(19) United States
(12) Patent Application Publication
(10) Pub. No.: US 2024/0124020 A1
(43) Pub. Date: Apr. 18, 2024

(54) STOPPING ACTION OF AN AUTONOMOUS VEHICLE

(71) Applicant: Zoox, Inc., Foster City, CA (US)

(72) Inventors: Ravi GOGNA, San Jose, CA (US); Alexander Jacques Maria MERTENS, San Francisco, CA (US); Ruikun YU, San Jose, CA (US)

(21) Appl. No.: 18/046,316

(22) Filed: Oct. 13, 2022

(51) Int. Cl. B60W 60/00; B60Q 1/52; B60W 50/14

(52) U.S. Cl. CPC B60W 60/0015; B60Q 1/52; B60W 50/14; B60W 2050/146; B60W 2554/80; B60W 2556/45

(57) ABSTRACT

A remote computer system may receive data associated with an autonomous vehicle traversing an environment along a route in accordance with a planned trajectory and data associated with an event within the environment and cause a display to display a representation of the autonomous vehicle. A request to generate an intermittent stopping action message comprising one or more of a position or orientation, a period of time, or a condition is received by the remote computer system and transmitted to the autonomous vehicle, wherein the autonomous vehicle is configured to move to the one or more of position or orientation for the period of time or until the condition is met, such that the vehicle moves to or is at the one or more of position or orientation prior to the event occurring.

### BACKGROUND

Planning components in autonomous and semi-autonomous vehicles determine actions for a vehicle to take in an operating environment. Actions for a vehicle may be determined based in part on avoiding objects present in the environment. However, sometimes, a teleoperator computer system can operate control over actions that a vehicle takes. To operate control over the vehicle, the teleoperator computer system may send one or more messages to the vehicle and the vehicle may alter its actions accordingly.

### BRIEF DESCRIPTION OF DRAWINGS

The detailed description is described with reference to the accompanying figures. The use of the same reference numbers in different figures indicates similar or identical components or features.

FIG. 1 is a pictorial diagram of an example environment, in which an example teleoperator computer system is in communication with an example vehicle computing system.

FIG. 2 is a flowchart depicting an example method at a remote computer system.

FIG. 3 is a flowchart depicting an example method at a vehicle.

FIG. 4 is a block diagram depicting an example system for implementing the techniques described herein.

FIG. 5 is an illustration of a vehicle and its trajectory, according to an example.

FIG. 6 is a block diagram of an example system for implementing the techniques described herein.

### DETAILED DESCRIPTION

This application relates to techniques, methods, systems, and computer-readable media for operating an autonomous vehicle in an environment, in particular, where a message is sent to the vehicle from a remote computer system and the vehicle carries out an action at a predefined location in the environment in accordance with the message.

In various examples, an autonomous vehicle traverses an environment along a route. A planner component of the autonomous vehicle may provide a planned trajectory for the vehicle to follow in order to traverse the route. The present disclosure describes in particular an autonomous vehicle system that may receive input from a teleoperator computer system, the input being to operate control over one or more actions of the autonomous vehicle as it executes the planned trajectory. For example, a teleoperator operating the teleoperator computer system may be viewing a display displaying a representation of the autonomous vehicle and thereby monitoring the autonomous vehicle in real-time as the vehicle navigates along the route. As part of the monitoring, the teleoperator may assess the environment through which the vehicle is travelling. As a result of assessing the environment, the teleoperator may identify a potential event or an event that the vehicle may encounter as the vehicle continues to execute the planned trajectory along the route. Examples of such an event may include a lorry stopping to unload goods, a stationary vehicle in a lay-by, a bus pulling out from a bus stop, and an emergency vehicle approaching the autonomous vehicle. A potential event is an event that has not yet occurred or started to occur within the environment, it can also be referred to as a future event. For example, as above, an event may be a bus pulling out from a bus stop, that is, the bus has started to pull out from the bus stop, whereas a potential event may be that the bus could pull out from the bus stop (but is currently stationary at the bus stop so has not begun to move away from the bus stop). As another example, a potential event or an event could involve the vehicle and may be a result of another event in the environment, for example, the vehicle becoming stuck or blocked by other vehicles or objects in the environment, the vehicle being stationary for too long, the vehicle being in an unsafe position, etc. In various examples, such events or potential events may be identified by a computing system associated with the teleoperator and one or more of flagged for the teleoperator's review or used to automatically initiate a remote operation of the autonomous vehicle.

For simplicity, the scenarios described herein will be limited to those of the teleoperator alone, though it should be understood that any method of flagging the potential event or the event and initiating the remote operation is contemplated. In addition, in certain parts of the disclosure, reference may be made to an event or a potential event, though it should be understood that the scenarios described herein are applicable to both an event and a potential event. The teleoperator computer system can, in response to input from the teleoperator, send a control message to the vehicle to preemptively avoid or lessen the effect of the potential event or the event on the vehicle, whereby the vehicle may update its planned trajectory within the environment in relation to a specified position or location, for example, by changing its speed or stopping at the specified position. As will be explained in more detail below, this can have benefits over conventional teleoperator computer systems that do not provide position or location-based control of an autonomous vehicle, in particular, in response to identifying a potential event or an event within the environment of the vehicle. For instance, the techniques described herein enable a teleoperator computer system to exercise preemptive control over the vehicle with respect to a potential event or an event so as to take control of how the vehicle maneuvers or otherwise operates with regards to the potential event or the event.

Generally, an event identified within the environment may require the vehicle to change how it is operating in the environment, for example, by coming to a stop. In such a scenario a teleoperator operating such a system may command a vehicle to stop, for example, by sending a message to the vehicle, and the vehicle may immediately execute a stopping action in response to the instruction and come to a stop thereafter. However, there are several variables relating to the vehicle and various conditions of the environment traversed by the vehicle that create uncertainty as to where the vehicle will be located when it has stopped moving. For instance, a current speed at which the vehicle is travelling when the vehicle receives the command to stop, the location of other vehicles within the environment, weather conditions of the environment, and the location of road obstacles, such as junctions, traffic lights, and pedestrian crossings within the environment. In addition, when the vehicle immediately executes a stop action, the timing of the command being received by the teleoperator computer system from the teleoperator and then sent to the vehicle by the teleoperator computer system also affects where the vehicle will be after it has completed the stopping action. In some instances, a teleoperator may endeavor to time the command based on the event occurring within the environment and, for example, the proximity of the event to the vehicle, in an attempt to bring the vehicle to a stop at a location where the effect of the event on the vehicle is lessened or avoided completely. However, it is difficult to time the command and the subsequent stopping action by the vehicle in this way due to the aforementioned variables relating to the vehicle and the environment, other variables relating to the event, and possible human error around the timing of such a command.

Uncertainty around the stopping position of a vehicle in an environment when the vehicle is instructed to come to a stop may lead to impedance of traffic flow and, in some instances, unsafe operation. To address this issue, the inventors have developed the various techniques described herein (including the use of a teleoperator system) that enable a location-based stopping message to be generated for a vehicle operating in an environment, particularly in anticipation of a future event within the environment, thereby reducing uncertainty around such stopping positions and ensuring optimal traffic flow around the stopped vehicle.

As such, in examples, there is provided techniques (including systems, non-transitory computer readable media, and methods) that may comprise: receiving, from a vehicle, data associated with the vehicle traversing an environment and data associated with an event within the environment; receiving a command comprising one or more of a position or an orientation; and transmitting a message to the vehicle, based on the command, wherein the message may configure the vehicle to determine an updated trajectory comprising the one or more of position or orientation and move to the one or more of the position or the orientation until one or more of a period of time has elapsed or a condition is met, such that the vehicle moves to or is at the one or more of position or orientation prior to the event occurring. Such a method may cause the vehicle to come to an intermittent stop at the predefined position and/or orientation whether the vehicle awaits the period of time to elapse or the condition to be met, because in both cases the vehicle has moved to the position or the orientation for a length of time and has therefore come to a stop. Since the position or orientation is predefined with respect to the message being transmitted to the vehicle, the position and/or orientation at which the vehicle is instructed to stop is known prior to the vehicle carrying out the stop, which may increase the certainty around the stopping position of the vehicle, thereby improving the operation of the vehicle.

The data associated with the event within the environment may be data relating to an event currently occurring within the environment or data relating to a potential event that may occur within the environment, where either type of event (current or potential) may affect the vehicle traversing the environment. Based on the data associated with the event, one of more of the following attributes may be determinable: when the event will start, when the event will stop, how long the event will last, the location of the event when it starts and stops and as the event is carried out, the proximity of the event to the vehicle. The determination of these event attributes may be carried out by one or more of a computing system of the vehicle, the remote computing system and an operator of the remote computing system.

In examples, the vehicle can be an autonomous vehicle traversing the environment along a route in accordance with a planned trajectory. In examples, the message may comprise the predefined period of time. One or more of the data and the command may be received at a remote computer system that is in communication with the vehicle.

In examples, the remote computing system may determine that the vehicle is able to proceed safely along the route, possibly after the vehicle has carried out the stop. In examples, the remote computing system may transmit an instruction to the vehicle to proceed along the route, wherein the vehicle is configured to proceed along the route in accordance with the updated trajectory in response to receiving the instruction.

In examples, the method may comprise causing a display to display a representation of the autonomous vehicle.

In some examples, the method may comprise: receiving, from the vehicle, a request to proceed; one or more of receiving or determining a response to the request; and transmitting the response to the vehicle, wherein the condition comprises receipt of the response by the vehicle. Here, the request to proceed may be a request to proceed along the route. The method may also comprise causing a display to display the request. The response may be indicative of allowing the autonomous vehicle to proceed. The vehicle may be an autonomous vehicle executing a trajectory along a route and the condition may comprise a determination that the autonomous vehicle is able to proceed safely along the route. A determination as to whether the vehicle is able to proceed safely may be based on a determined likelihood of the vehicle encountering another event along the route and/or a likelihood of the route being obstructed by other objects within the environment, for example, other vehicles or pedestrians. A level of safety of proceeding may be calculated based on the determined likelihoods of other events or obstructions along the route and compared to a predefined scale, rule, or threshold. The determined likelihood may be assessed by a teleoperator of a teleoperator computing system that has received data associated with the vehicle and data associated with the event.

In examples, the position or the orientation can be within a stopping range of the vehicle, the stopping range having a minimum corresponding to the minimum stopping distance of the vehicle based at least in part on a current speed of the autonomous vehicle.

In examples, the message may further configure the vehicle to perform one or more of: emit, as a passenger communication, one or more of an audio message or a video message internal to the vehicle; emit, as a pedestrian communication, one or more of a light or sound external to the vehicle; or initiate display of hazard lighting. The emittance of the passenger communication may be the playing of the audio or video message via output means, such as speakers and/or a display, located on the inside of the vehicle and accessible to the one or more passengers. The emittance of the pedestrian communication may be the turning on of one or more lights located on the exterior of the vehicle such that the lights are visible to a pedestrian and/or the playing of a sound via a speaker located on the exterior of the vehicle.

In examples, the method may further comprise: determining, based at least in part on the data associated with the vehicle and the data associated with the event, a likelihood associated with the vehicle encountering the event. In some examples, the method may comprise causing a display to display an indication of the likelihood. Determining the likelihood associated with the vehicle encountering the event may also be based on a planned trajectory of the vehicle. The likelihood may be determined by a teleoperator assessing the aforementioned data. Alternatively, the likelihood may be determined by a vehicle computing system on the vehicle. An event may be something taking place within the environment and/or at a point on the route along which the vehicle is travelling. A potential event may be something that could take place within the environment and/or at a point on the route along which the vehicle is travelling.

The event or potential event may be associated with one or more objects within the environment. For example, an emergency vehicle approaching the vehicle, a build-up of traffic on the route ahead of the vehicle, a heavy goods vehicle maneuvering across or in proximity to the route, an incident involving another vehicle on the route ahead or on the other side of the road, and the presence of debris on the route that obstructs the flow of traffic, etc. In examples, one or more of the following may apply: the vehicle may travel or be projected to travel within a certain distance of one or more objects associated with the event, the event may be occurring or be anticipated to occur (a potential event) at any point on the planned trajectory of the vehicle, and the vehicle may be affected or anticipate being affected (a potential event) by the behaviour of one or more objects reacting to the event, for example, being obstructed by the one or more objects. In some examples, a time associated with an event may be after a time associated with receipt of the message by the vehicle, such that receiving the message at the vehicle precedes the time associated with the event. In this way, the message serves to control an action of the vehicle before the vehicle is affected by the event, thereby avoiding a situation where the event escalates and the vehicle is in an undesirable environment or position therein, without being able to progress along the route. For example, the vehicle may become blocked by another vehicle, such as a lorry reversing into a side road and, as a result, be held at a location for a period that delays the progress of the vehicle along the route.

In examples, the position and/or the orientation can be defined in a world frame of reference and the method may further comprise one or more of: converting the position or the orientation into a second position defined in relation to a frame of reference of the autonomous vehicle; calculating, a distance, s, between a current position of the autonomous vehicle and either the second position in the frame of reference of the autonomous vehicle or the position in the world frame of reference; and updating the trajectory to include an intermittent stop at the distance. The world frame of reference defines the position or orientation using a global coordinate system. The frame of reference of the autonomous vehicle may be a coordinate system defined in relation to the current position of the vehicle, whereby the position or orientation can be defined using the frame of reference of the vehicle so that the vehicle, in particular, its planning component, can understand and interpret where the stop location is in relation to a localized frame of reference and update the trajectory of the vehicle, accordingly.

Accordingly, implementing the techniques described herein can provide increased certainty as to the position of the vehicle in the environment after the vehicle has received a message to stop and improve the response of the vehicle to a potential event. In doing so, control over the operation of the vehicle within the environment may be more precise and can be exercised in anticipation of a potential event and can, therefore, improve the performance of the vehicle in executing the planned trajectory, particularly in response to events occurring or anticipated to occur within the environment. In addition, the accuracy of the planner component of the vehicle may be improved, thereby improving the performance of other computing devices on the vehicle that interact with the planner component. Further, such techniques may ensure the flow of traffic, improve safe operation of the vehicle, and ensure optimal response to an event.

The techniques described herein can be implemented in a number of ways. Example implementations are provided below with reference to the accompanying figures. Although discussed in the context of an autonomous vehicle, the methods, apparatuses, and systems described herein can be applied to a variety of systems and is not limited to autonomous vehicles. In another example, the techniques can be utilized in an aviation or nautical context. Additionally, the techniques described herein can be used with real data (e.g., captured using sensor(s)), simulated data (e.g., generated by a simulator), or any combination of the two.

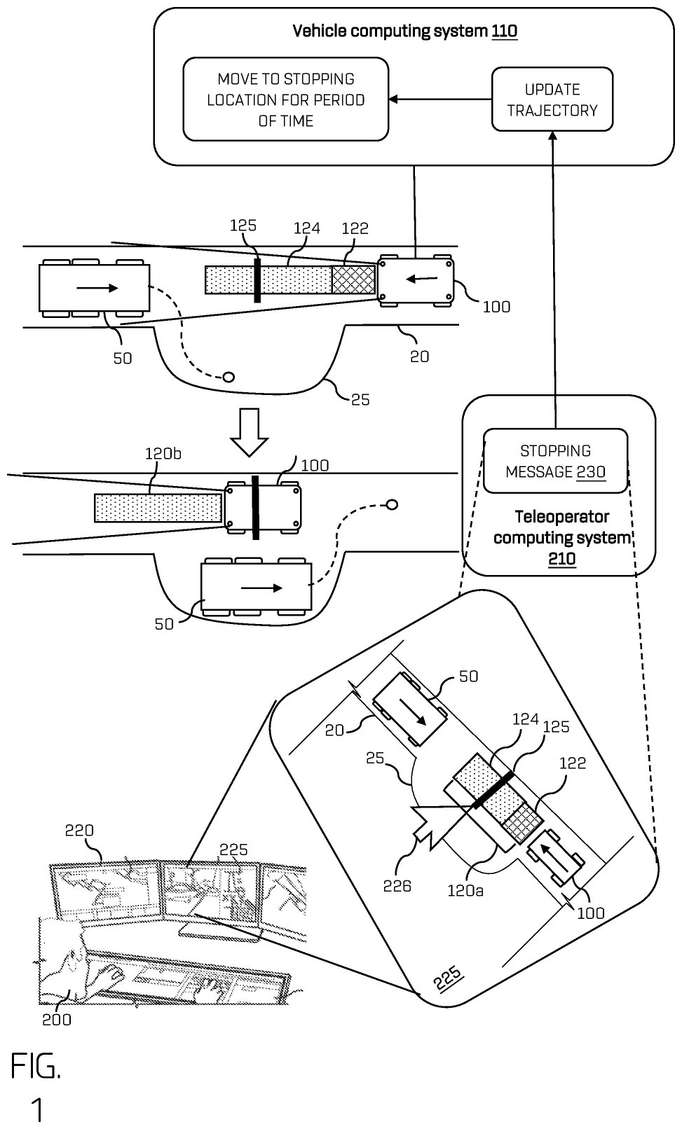

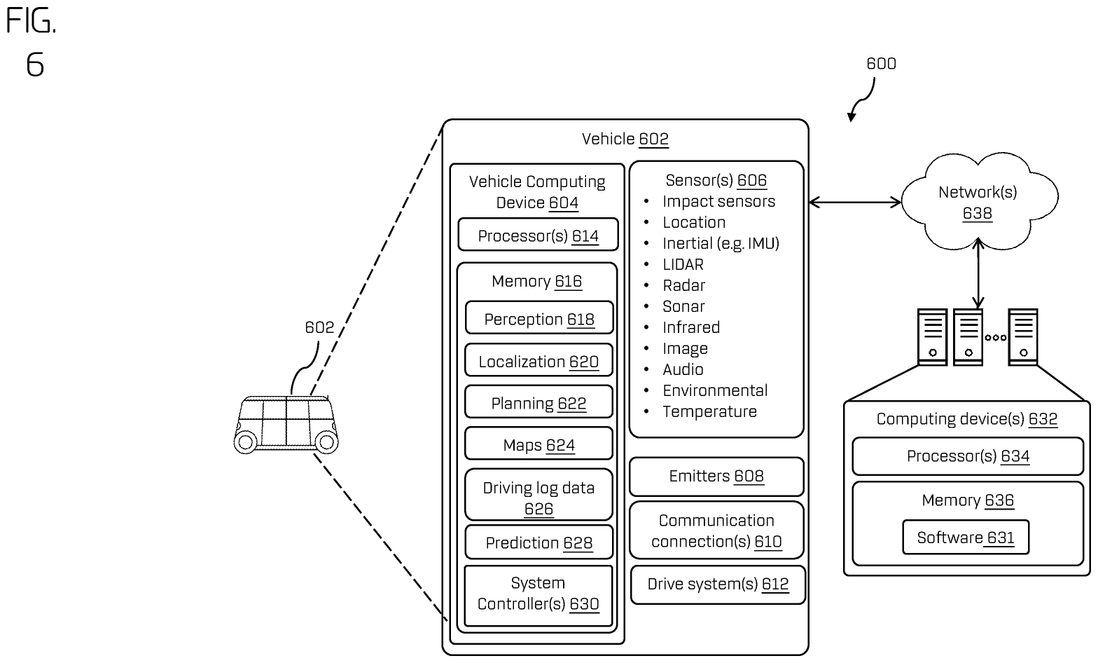

FIG. 1 is a pictorial diagram of an example environment, in which an example teleoperator computer system 210 is in communication with an example vehicle computing system 110 of a vehicle 100. The vehicle 100 of this example may be an autonomous or semi-autonomous vehicle and comprises the vehicle computing system 110. As will be appreciated, vehicle 100 may comprise additional components not shown in FIG. 1, for example, the components depicted by and described in relation to vehicle 602 of FIG. 6.

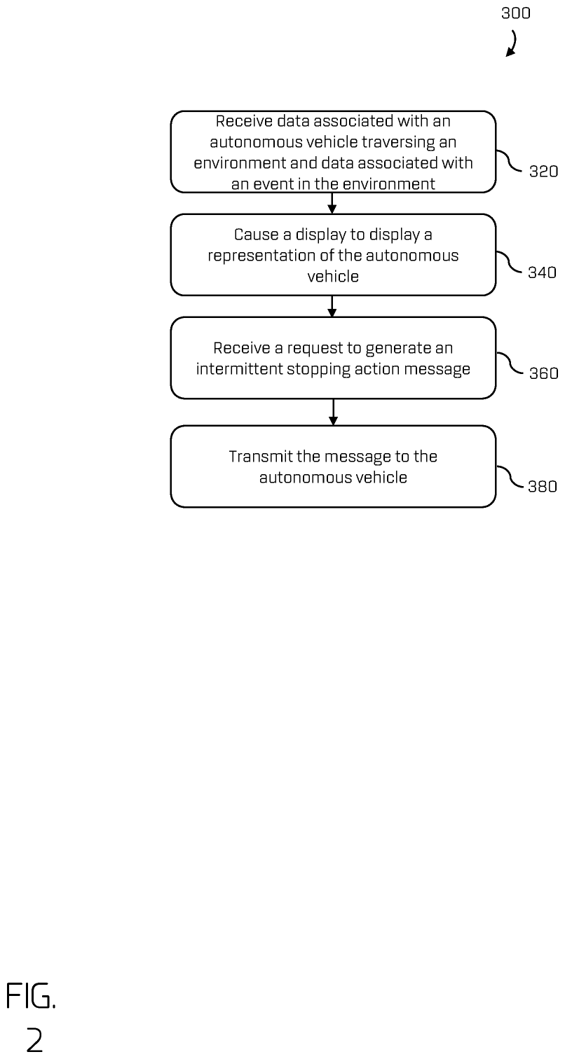

The teleoperator computer system 210 may be a remote computer system with respect to the vehicle 100, whereby the teleoperator computer system 210 is located at a different location to that of the vehicle 100. The teleoperator computer system 210 may comprise a display 220 that displays a user interface 225. In this example, the teleoperator computer system 210 may be operated by a teleoperator 200, also referred to as a tactician. The teleoperator 200 can operate the teleoperator computer system 210 via the user interface 225 and one or more components of input hardware associated with the teleoperator computer system 210, for example, a keyboard, a mouse, a microphone (via speech input), a camera (via gesture input), a touchscreen, and a touch pad. In the example of FIG. 1, the teleoperator 200 can operate an input component to move a user interface cursor 226 on the user interface 225. A method 300 performed by the teleoperator computer system 210 in accordance with the example of FIG. 1 is described in relation to FIG. 2.

With reference to FIG. 1, the teleoperator computer system 210 may receive data associated with the vehicle 100 traversing the environment along a route in accordance with a planned trajectory. The data may be used by the teleoperator computer system 210 to cause the display 220 to display a user interface 225 comprising a representation of the vehicle 100 as it traverses the environment in accordance with the planned trajectory 120a, which may be planned by a planner component of the vehicle computing system 110. Such representations may comprise, for example, actual sensor data received from the vehicle or data derived therefrom (e.g., bounding boxes of other objects in the environment proximate the vehicle 100) which may be overlayed onto a map, or otherwise, in conjunction with any other representation (e.g., some combination of sensor data and representative data). In this way, the teleoperator 200 can monitor the vehicle 100 in real-time as the vehicle 100 moves through the environment. The data may be collected by a sensor system of the vehicle 100, for example, sensor system 606 of FIG. 6, whereby the data is representative of the surroundings of the vehicle 100 in the environment and the relative positioning of the vehicle therein, such that the teleoperator computer system 210 can generate the representation of the vehicle 100 and display the representation on the display 220.

In some examples, the teleoperator computing system 210 may also receive data associated with an event in the environment from the vehicle, possibly at the same time as the data associated with the vehicle is received by the system 210. Similar to the vehicle data, the data associated with the event may be collected by a sensor system of the vehicle 100, for example, sensor system 606 of FIG. 6.

In such scenarios, the teleoperator computer system 210 may be configured to detect a potential event within the environment. The detection of a potential event may be based on the data associated with the event received by the teleoperator computing system 210.

After a potential event is detected, the teleoperator computing system 210 may notify the teleoperator 200 of the potential event for further consideration by the teleoperator 200. The potential event may be flagged to the teleoperator 200 via one or more of the following: displaying a visual notification on the display 220, generating an audio notification outputted by an output hardware component of the teleoperator computing system 210, such as a speaker, and generating a tactile notification outputted via one or more of the input means used by the teleoperator 200, for example, by causing a vibration of a mouse, keyboard or a touchscreen of the teleoperator computing system 210.

In the example of FIG. 1, the user interface 225 depicts the vehicle 100 moving in a first direction along a road 20. A portion 120a of the route, also referred to as route portion 120a, of the vehicle 100 is depicted as extending in front of the vehicle 100 and is representative of the direction of travel of the vehicle 100 within the environment, in accordance with its planned trajectory. Another vehicle 50, in this example a lorry, is depicted as moving in a second direction along the road 20 and at a distance away from the vehicle 100, where the second direction is opposite to the first direction of the vehicle 100. As illustrated, there is only enough space for one of the vehicles (either lorry 50 or vehicle 100) to pass and continue travelling along the road 20. Given that, the environment represented (and data representative thereof) presents a likelihood of an event at some point in the future (here, an impasse if neither vehicle moves appropriately).

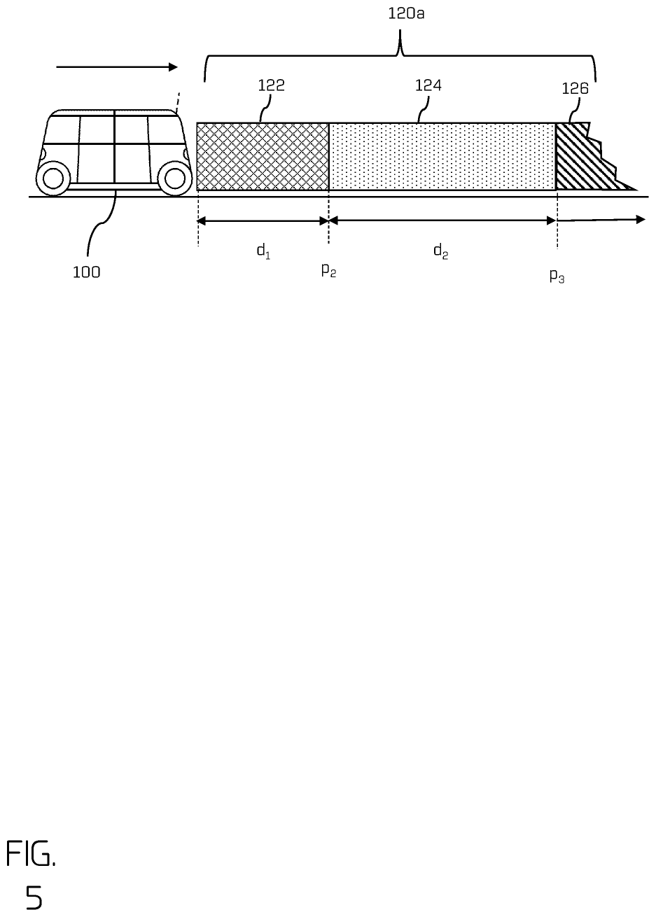

The depicted portion of the route 120a in FIG. 1 comprises a first zone 122 and a second zone 124, discussed in more detail in relation to FIG. 5.

In the example of FIG. 1, the teleoperator 200 may recognize the likelihood that such an event may occur if the teleoperator does not intervene and, as described above, the remote teleoperator computing system 210 may flag such an event to the teleoperator. In a slight variation, in addition to or as an alternative to the teleoperator computing system 210 flagging the event, the vehicle 100 may transmit a likelihood of the event to the teleoperator computing system 210 which, in some examples, may comprise an indication that the vehicle 100 needs to stop. The likelihood of the event may be incorporated into the data associated with the event that is received by the teleoperator computing system 210. In response to any of the foregoing, the teleoperator 200 may select a stop location 125 within the second zone 124 of the route portion 120a of the vehicle 100. As previously mentioned, in this example the teleoperator 200 may use the user interface cursor 226 to select the stop location 125. Selecting the stop location 125 may cause a request to be input to the teleoperator computer system 210 to generate an intermittent stopping action message 230 for the vehicle 100. Alternatively, a request being input to the teleoperator computer system 210 may be caused by an input from the teleoperator that is different from, and made in addition to, selecting the stop location 125.

In other examples, the request to generate the intermittent stopping action message 230 may be input to the teleoperator computer system 210 in different ways, other than the use of a cursor to select a location represented on the display 220 of the teleoperator computer system 210. For example, the request may be input by the teleoperator 200 via other input means, discussed above. Alternatively, the request may be received at the teleoperator computer system 210 from the vehicle 100 via the vehicle computing system 110. For instance, the vehicle computing system 110 may detect a potential event involving the vehicle 100 and the lorry 50 (for example, an impasse), and in some scenarios, determine a likelihood of the event occurring, and request input from the teleoperator computer system 210 or the teleoperator 200 on how to navigate the planned trajectory. The request for input may be made in addition to the provision of data relating to the event to the teleoperator computing system 210. For example, a request for input may be made in response to the vehicle computing system 110 or a passenger within the vehicle 100 identifying a situation relating to a potential event within the environment, in this example, the approach of lorry 50, or a situation relating to the vehicle 100 itself, for which the vehicle computing system 110 or passenger requests guidance from the teleoperator computer system 210. Alternatively, a passenger may communicate directly with the teleoperator computer system 210, rather than via the vehicle computing system 110, to request guidance from the teleoperator computer system 210 and/or an associated teleoperator 200. In a scenario where the request for the teleoperator computer system 210 to generate the intermittent stopping action message 230 originates from an entity other than the teleoperator 200, such as the vehicle computing system 110, or a passenger of the vehicle 100, in response to the request, the teleoperator computer system 210 may prompt the teleoperator 200 to select a stop location 125. Irrespective of which entity detects that there is potential event within the environment, which entity determines the associated likelihood of that event, and/or which entity requests input from the teleoperator computing system, the early detection, determination and requesting provide a way to preemptively manage operation of the vehicle 100 in relation to a potential event in the environment.

In the example of FIG. 1, the stopping location 125 is located alongside a passing place 25 of the road 20. It is understood that by selecting the stopping location 125, the teleoperator 200 may be requesting that the vehicle 100 is instructed via the intermittent stopping action message 230 to come to a stop at the stopping location 125, in this scenario, alongside the passing place 25 to allow the lorry 50 to drive into the passing place 25.

In some examples, a number of candidate stop locations may be suggested to the teleoperator either by the teleoperator computing system 210 or the vehicle computing system 110. The candidate stop locations may be identified based on the data associated with the vehicle traversing the environment and the data associated with a potential event within the environment.

In response to the request from the teleoperator 200, the teleoperator computer system 210 may generate the intermittent stopping action message 230. The intermittent stopping action message 230 may comprise data indicative of the stop location 125. The teleoperator computer system 210 may transmit the intermittent stopping action message 230 to the vehicle 100. The vehicle computing system 110 may receive the message 230 and may be configured by the vehicle computing system 110 to determine an updated trajectory that comprises the stop location 125 and to execute the updated trajectory to move to the stop location 125 until one or more of a predefined time period has elapsed or a condition is met. The movement of the vehicle 100 to the stop location and the temporary stop at the stop location by the vehicle 100 may result in the potential impasse event of the example of FIG. 1 being avoided. Accordingly, under different circumstances to those in the example of FIG. 1, preemptive use of the intermittent stopping action message and subsequent operation of respective autonomous vehicles can avoid or lessen the effect of other types of events on those vehicles. As shown in FIG. 1, the route portion 120a has been updated to a route portion 120b in response to the updating of the vehicle trajectory to incorporate the stop at stop location 125. The route portion 120b is comprised of zone 124 since the vehicle 100 is stationary in the depicted instance so there is no zone of the route portion 120b in which the vehicle is unable to come to a stop, for example zone 122 of the trajectory 120a.

The data indicative of the stop location 125 that may be incorporated into the intermittent stopping action message 230 may comprise one or more of a position or orientation, indicative of the stop location 125, and a period of time. A position indicative of the stop location 125 may be a positional characteristic that defines where the stop location is within the environment through which the vehicle is traversing. For example, the data indicative of the stop location 125 may be defined by the teleoperator computer system 210 as a position in a first frame of reference in which the environment and vehicle 100 are displayed on the display 220. For example, a world frame of reference, such as Universal Transverse Mercator (UTM) co-ordinates. In such a scenario, the vehicle computing system 110 may be configured to translate the position defined in relation to the first frame of reference into a position defined in relation to a second frame of reference understood by the vehicle computing system 100 in relation to the trajectory of the vehicle 100, for example, a frame of reference of the vehicle 100.

An orientation of the stop location 125 is a directional characteristic that defines the direction that the vehicle 100 will face at the stop location 125. For example, this can be defined with respect to a world frame of reference, such as cardinal directions (for example, north, east, south, west) and ordinal directions (for example, northeast, and southeast). In another example, the orientation of the stop location can be defined in relation to a frame of reference of the vehicle 100, for example, using angles relative to the trajectory of the vehicle 100 (e.g., a heading).

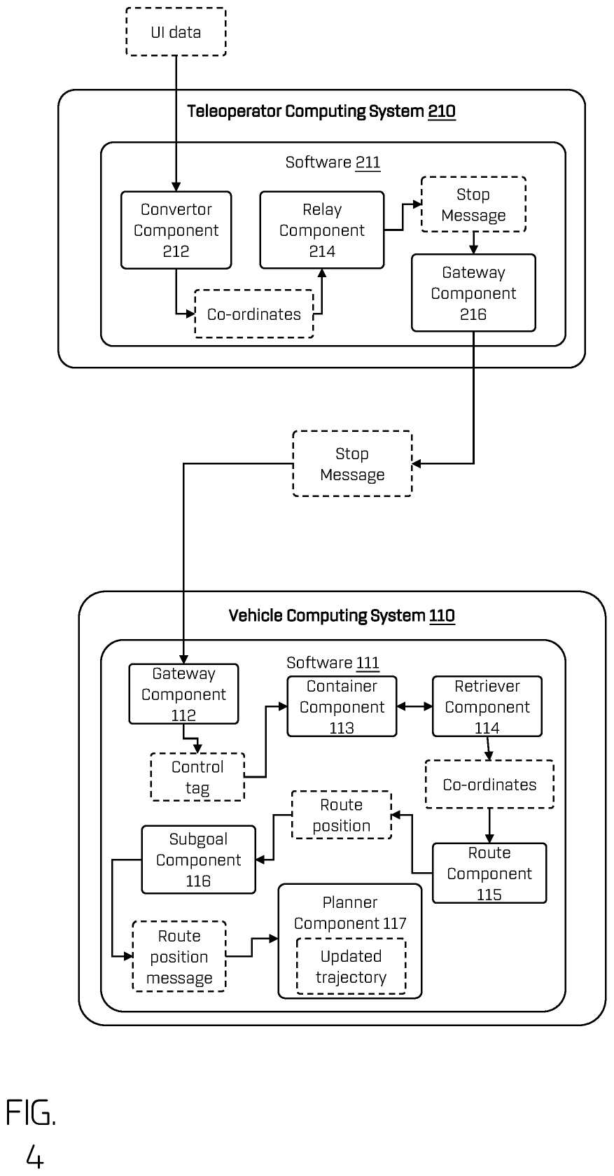

The translation of one or more of the position or the orientation into a frame of reference of the vehicle 100 is discussed in more detail in relation to FIG. 4 below.

The period of time that may be incorporated into the intermittent stopping action message 230 can define how long the vehicle 100 should perform an intermittent stop (sometimes referred to as a temporary stop) at the stop location 125. The period of time may be determined by the teleoperator 200 based on real-time conditions of the environment (in this example, this could be a determined speed of the lorry 50) and inputted into the teleoperator computer system 210, may be determined by the teleoperator computer system 210 based on one or more rules relating to the operation of the vehicle 100 (for example, a rule relating to power-saving, a rule relating to proximity of the vehicle to other objects in the environment), or may be predefined and stored by the teleoperator computer system 210 for the purpose of intermittent stopping action messages.

Alternatively, the vehicle computing system 110 may determine that the vehicle 100 can proceed along its planned trajectory once the period of time has elapsed. In the example of FIG. 1, the vehicle computing system 110 may determine one or more of the following: that the route portion 120b is not obstructed by the lorry 50, that the lorry 50 is positioned within the passing place 25, that the lorry 50 is stationary in the passing place 25, that the lorry 50 is moving in a direction away from the vehicle 100. In this way, the vehicle computing system 110 does not need to await further communication from the teleoperator computing system 210 in order for the vehicle 100 to continue to traverse the environment.

FIG. 2 is a flowchart depicting an example method 300 of a remote computer system, such as the teleoperator computer system 210 of FIG. 1.

At step 320, the teleoperator computer system 210 may receive data associated with an autonomous vehicle, such as vehicle 100 of FIG. 1, traversing an environment along a route in accordance with a planned trajectory and data associated with an event within the environment, such as the environment displayed by the user interface 225 on the display 220 of the teleoperator computer system 210 of FIG. 1. The data associated with the vehicle may be representative of the surroundings of the vehicle 100 in the environment and the relative positioning of the vehicle 100 therein. The data associated with the vehicle and the data associated with the event may be received from the vehicle 100.

At step 340, the teleoperator computer system 210 may cause a display, such as display 220 of the teleoperator computer system 210, to display a representation of the autonomous vehicle, for example, vehicle 100.

At step 360, the teleoperator computer system 210 may receive a request to generate an intermittent stopping action message 230, the message 230 comprising: one or more of a position or orientation, and a period of time, where the one or more of the position or orientation and the time period are either included within the request to generate the intermittent stopping action message, received in a separate request, or determined by the teleoperator computer system 210 in response to receipt of the request. In the example of FIG. 2, the request received by the teleoperator computing system at step 360 may be inputted to the system 210 by the teleoperator 200. In some examples, the request does not comprise a period of time. For these scenarios, the period of time for the intermittent stopping action may be determined by the teleoperator computer system 210 and incorporated into the intermittent stopping action message 230 or may be determined by the vehicle computing system 110 in response to receipt of the intermittent stopping action message 230.

At step 380, the teleoperator computing system 210 may transmit the intermittent stopping action message to the vehicle computing system 110 of the vehicle 100.

In some examples, prior to transmitting the intermittent stopping action message to the vehicle computing system 110 and after receiving the data at step 320, the teleoperator computing system 210 may determine, based at least in part on the data received at step 320 and the planned trajectory of the vehicle 100, a likelihood that the vehicle 100 will encounter an event within the environment and may cause the display to display an indication of the likelihood. The determination of the likelihood may be based on input from a teleoperator of the teleoperator computing system 210. Such an event may be identified by the teleoperator 200, the teleoperator computer system 210, or the vehicle computing system 110 to be an action that will occur or is currently occurring within the environment in such a way that will affect or be likely to affect the vehicle 100 as it traverses the environment. For example, an event may be one or more of the following: a lorry stopping to unload goods, a stationary vehicle in a lay-by, a bus pulling out from a bus stop, an emergency vehicle approaching the autonomous vehicle, etc. By way of examples only the vehicle 100 may be affected by an event if the vehicle computing system 110 determines that there should be a change in the direction of the planned trajectory of the vehicle, a change in the speed of the vehicle, or that the vehicle 100 should perform an immediate stop, which may cause an uncertainty, temporary or otherwise, in the location of the vehicle 100 in the environment.

In some examples, a time associated with an event may be determined. The time may be a time that the event is likely to commence, a time that the event started, a time that the event is likely to finish, a time at which the event is ongoing, or a time that the event is likely to be in proximity, or greatest proximity, to the vehicle 100. The determination of the time may be based on a current speed of an object or vehicle associated with the event, which may be calculated by the teleoperator computer system 200 by analyzing the data associated with the vehicle 100. For instance, the data associated with the vehicle 100 may comprise data associated with an object or vehicle associated with the event, for example, a current speed of a group of pedestrians within the environment, where it is likely the group of pedestrians will cross the road at an upcoming junction, the crossing of the road by the pedestrians being the event in this example. In some examples, the receipt of the request at step 360 by the teleoperator computer system 210 precedes a time associated with the event, such that the teleoperator computer system 210 can send the stopping message to the vehicle computing system 110 before the event has started or whilst the event is ongoing.

In some examples, during or after the intermittent stopping action, the vehicle computing system 110 may transmit a request to the teleoperator computer system 210 to proceed to traverse the environment. In response, the teleoperator computer system 210 may determine whether the vehicle 100 can proceed or receive input for a response to the request where the input may be determined and provided by the teleoperator 200. Whether or not the teleoperator 200 is involved in determining that the vehicle can proceed to traverse the environment, the teleoperator computer system 210 may transmit a response to the vehicle computing system 110, whereby in some examples, receipt of the response by the vehicle computing system 110 may constitute a condition, that when met, configures the vehicle 100 via the vehicle computing system 110 to cease the intermittent stopping action. In other examples, the vehicle computing system 110 may not generate and transmit any request to the teleoperator computing system 210 and may not await instruction to proceed, instead, the vehicle computing system 110 may be configured to determine whether to proceed in accordance with the updated trajectory without input from another entity.

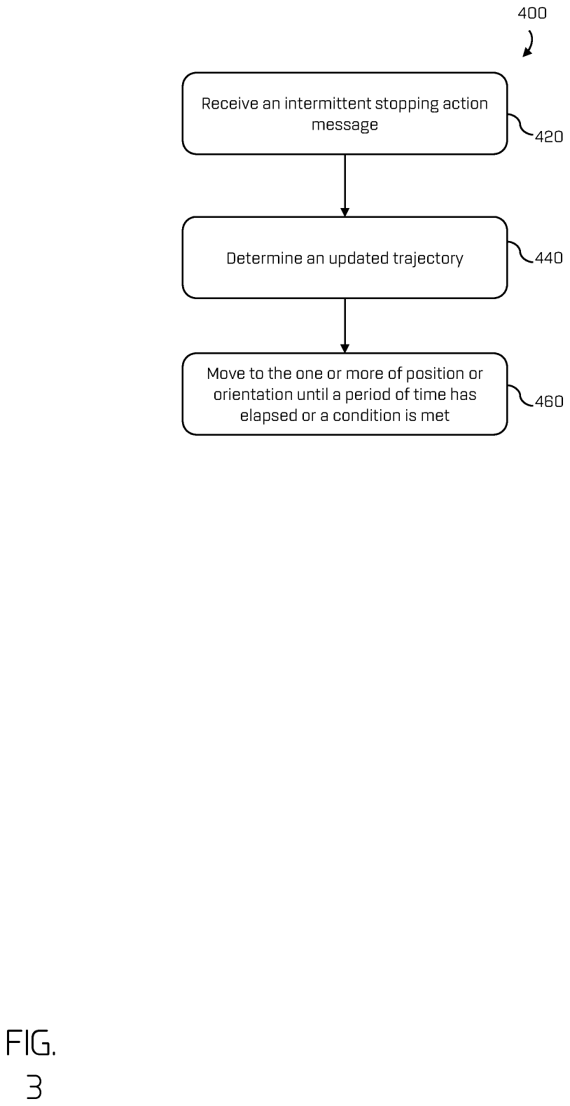

FIG. 3 is a flowchart depicting an example method 400 of a vehicle computing system, such as the vehicle computing system 110 of the vehicle 100 in FIG. 1 traversing a route in an environment.

At step 420, the vehicle computing system 110 of the vehicle 100 may receive an intermittent stopping action message.

At step 440, the vehicle computing system 110 may determine an updated trajectory by incorporating the intermittent stop at the stop location specified within the intermittent stopping action message.

At step 460, the vehicle 100 may be configured via the vehicle computing system 110 to move to one or more of a position or orientation specified in the intermittent stopping action message in accordance with its updated trajectory. The vehicle 100 may be configured to remain at the position or orientation until at least one of the following has occurred: a period of time has elapsed, where the period of time may be specified in the intermittent stopping action message; or a condition has been met. As an example, a condition may comprise a determination that the vehicle 100 is able to proceed safely along its route. Such a determination may be carried out by the vehicle computing system 110 of the vehicle 100, for example, through use of data captured by a sensor system of the vehicle 100, such as sensor system 606 of FIG. 6. Alternatively, the determination may be carried out by the teleoperator computer system 210 performing analysis of data associated with the vehicle 100 and/or the environment or a teleoperator 200 that assesses the safety of the vehicle 100 based on the representation of the vehicle 100 and its surrounding environment displayed by the teleoperator computer system 210. A determination that the vehicle 100 can proceed safely along its route may be a determination that the event which prompted the intermittent stop has finished, a determination that the event is no longer affecting the progression of the vehicle 100 along its trajectory, or a determination that the event is no longer in proximity to the vehicle 100.

In some examples, at step 460, the vehicle 100 may be configured to perform one or more other actions in addition to the intermittent stopping action. The other actions may comprise one or more of: emitting, as a passenger communication, one or more of an audio message or a video message internal to the vehicle 100; emitting, as a pedestrian communication, one or more of a light or sound external to the vehicle 100; or initiating display of hazard lighting. The one or more other actions may be specified within the intermittent stopping action message or the vehicle computing system 110 may determine the vehicle 100 to carry out the one or more actions as a result of receiving the intermittent stopping action message.

FIG. 4 is a block diagram depicting an example system and a visual flowchart for implementing the techniques described herein. In particular, the visual flowchart of FIG. 4 depicts the generation of the intermittent stopping action message at the teleoperator side and the interpretation of the intermittent stopping action message at the vehicle side, from a software perspective. The example system may comprise the teleoperator computer system 210 and the vehicle computing system 110, described in relation to FIGS. 1-3. The teleoperator computer system 210 may comprise software 211. The running of software 211 by the teleoperator computer system 210 can enable method 300 of FIG. 2 to be performed. Similarly, the vehicle computing system 110 comprises software 111 and the running of software 111 by the vehicle computing system 110 can enable method 400 of FIG. 3 to be performed.

Software 211 may comprise the following executable software components: a convertor component 212, a relay component 214 and a gateway component 216.

The convertor component 212 may be configured to retrieve data representative of a position on a user interface, as an example, the data may be representative of a teleoperator clicking on an environment displayed by the user interface, such as the teleoperator 200 clicking on a position of the user interface to select a stop location. The convertor component 212 may further be configured to convert the data representative of a position on the user interface into a position in a world frame of reference, such as a world co-ordinate system, for example UTM co-ordinates. The convertor component 212 may also be configured to call the relay component 214.

The relay component 214 may be configured to incorporate the co-ordinates into a stop message, such as the intermittent stopping action message described in relation to FIG. 1, that will be sent to the vehicle computing system 110. The relay component 214 may also be configured to initiate the sending of the stop message by calling the gateway component 216.

The gateway component 216 may be configured to send the stop message to the vehicle computing system 110.

Software 111 of the vehicle computing system 110 may comprise the following software components: a gateway component 112, a container component 113, a retriever component 114, a route component 115, a subgoal component 116 and an execution component 117.

The gateway component 112 may be configured to receive the stop message from the teleoperator computer system 210 and extract the data from the stop message, the extracted data being referred to as a control tag, since it can be used to control the actions of the vehicle 100.

The container component 113 may be configured to store the control tag until the vehicle computing system 110 receives another request containing an updated control tag.

The retriever component 114 may be configured to retrieve the co-ordinates from the control tag stored in the container component 113. The retrieval may be performed by a getter method.

The route component 115 may be configured to project the co-ordinates onto a current route of the vehicle 100 and thereby convert the co-ordinates into a route position defined in relation to a frame of reference of the vehicle 100.

The subgoal component 116 may be configured to create a message containing the route position, referred to as a route position message. The route position message is provided to a planner component 117 (discussed in more detail in relation to reference 622 of FIG. 6). In some examples, the subgoal component 116 may be configured to calculate a distance, s, between a current position of the vehicle 100 and the route position of the stop.

The planner component 117 may be configured to update the trajectory of the vehicle 100 to include a stop at the route position, thereby creating an updated trajectory. The updated trajectory may then be executed by the vehicle 100 and, as a result, the vehicle 100 may move to the stop position. The execution of the updated trajectory may be implemented by the planner component 117.

In some examples, the planner component 117 of the software 111 of the vehicle computing system 110 may comprise or be configured to call one or more of the aforementioned components 112-117. Alternatively, other components of vehicle 100 may comprise any of components 112-117. The planner component and other components of the vehicle 100 are described in more detail in relation to FIG. 6.

Whilst in FIG. 4 software 211 of the teleoperator computer system 210 and software 111 of the vehicle computer system 110 are described as comprising a number of specific software components, in other examples, the number of software components and the respective functions thereof may differ, for example, by combining one or more of the software components, yet still enabling the teleoperator computer system 210 and the vehicle computer system 110 to implement methods 300 and 400, respectively.

FIG. 5 is a is an illustration of a vehicle 100 and a route portion 120a, according to an example. The route portion 120a of FIG. 5 is a depiction of a portion of a path that the vehicle 100 will take as it traverses an environment in accordance with a planned trajectory. The planned trajectory can be updated as the vehicle 100 progresses along the route in order to navigate changing conditions within the environment, for example, the actions of other vehicles, pedestrians, cyclists in the environment. The trajectory may be updated by the vehicle computing system 110, in particular the planner component 117 of FIG. 4.

The route portion 120a may comprise a first zone 122, a second zone 124, and a third zone 126. The first zone 122 may cover a first distance d₁ and ends at point p₂ that is equivalent to a minimum stopping distance of the vehicle 100, such that point p₂ is the earliest point at which the vehicle 100 is capable of stopping. The minimum stopping distance may be determined based at least in part on the current speed of the autonomous vehicle and, in some examples, one or more of: a rate of deceleration of the vehicle 100, a distance travelled by the vehicle 100 before it starts to decelerate (sometimes referred to as a reaction distance), and conditions of the route, such as a friction coefficient representative of the route surface.

The second zone 124 may cover a second distance d₂ that starts at point p₂ and ends at point p₃. The second zone 124 is the area in which an intermittent stopping action can be performed by the vehicle 100 so is understood to be a stopping range of the vehicle 100. The stopping location 125 of FIG. 1 is located within the second zone 124 of the route portion 120a.

The upper limit of the second zone 124 at point p₃ may be set at a position where beyond this point is the third zone 126. It may be determined that the likelihood of the trajectory of the vehicle, and thus the route portion 120a, being updated within the third zone 126, beyond p₃, is above a threshold likelihood that means that an intermittent stopping action will likely not be able to be reliably performed by the vehicle 100 due to changes in the environment and the trajectory as the vehicle 100 progresses along the route. In other examples, point p₃ may be a configurable position that is dependent on the environment in which the vehicle is being operated (for example, in a city setting point p₃ may be set at a shorter distance than in a rural setting due to the higher likelihood of the vehicle interacting with other objects as it traverses the environment in accordance with its trajectory) and/or the driving speed of the vehicle. In some examples, point p₃ may be configurable by the teleoperator 200 of the teleoperator computing system 210.

FIG. 6 is a block diagram illustrating an example system 600 for implementing some of the various technologies described herein. In some examples, the system 600 may include one or multiple features, components, and/or functionality of examples described herein with reference to other figures.

The system 600 may include a vehicle 602. In some examples, the vehicle 602 may include some or all of the features, components, and/or functionality described above with respect to the example vehicle 100. As shown in FIG. 6, the vehicle 602 may also include a vehicle computing device 604, one or more sensor systems 606, one or more emitters 608, one or more network interfaces or communication connections 610, and one or more drive systems 612. The vehicle computing system 110 of FIG. 1 may be equivalent to a combination of one or more of components 604, 606,608, 610 and 612 of FIG. 6.

The vehicle computing device 604 can, in some examples, include one or more processors 614 and memory 616 communicatively coupled with the one or more processors 614. In the illustrated example, the vehicle 602 is an autonomous vehicle; however, the vehicle 602 could be any other type of vehicle (e.g., automobile, truck, bus, aircraft, watercraft, train, etc.), or any other system having components such as those illustrated in FIG. 6. In examples, the one or more processors 614 may execute instructions stored in the memory 616 to perform one or more operations on behalf of the one or more vehicle computing devices 604.

The memory 616 of the one or more vehicle computing devices 604 can store a perception component 618, a localization component 620, a planning component 622, a map(s) component 624, driving log data 626, a prediction component 628, and one or more system controllers 630. Though depicted in FIG. 6 as residing in memory 616 for illustrative purposes, it is contemplated that the perception component 618, the localization component 620, the planning component 622, the map(s) component 624, the log data 626, the prediction component 628, and/or the one or more system controllers 630 can additionally, or alternatively, be accessible to the vehicle 602 (e.g., stored on, or otherwise accessible from, memory remote from the vehicle 602, such as memory 636 of one or more computing devices 632, such as the teleoperator computing system 210 of FIG. 1).

In at least one example, the localization component 620 can include functionality to receive data from the sensor system(s) 606 to determine a position and/or orientation of the vehicle 602 (e.g., one or more of an x-, y-, z-position, roll, pitch, or yaw). For example, the localization component 620 can include and/or request/receive a map of an environment and can continuously determine a location and/or orientation of the autonomous vehicle within the map. In some instances, the localization component 620 can utilize SLAM (simultaneous localization and mapping), CLAMS (calibration, localization and mapping, simultaneously), relative SLAM, bundle adjustment, non-linear least squares optimization, or the like based on image data, lidar data, radar data, IMU data, GPS data, wheel encoder data, and the like captured by the one or more sensor systems 606 or received from one or more other devices (e.g., computing devices 636) to accurately determine a location of the autonomous vehicle 602. In some instances, the localization component 620 can provide data to various components of the vehicle 602 to determine an initial position of the autonomous vehicle 602 for generating a trajectory and/or for determining to retrieve map data. In various examples, the localization component 620 can provide data to a web-based application that may generate a data visualization associated with the vehicle 602 based at least in part on the data.

In some instances, the perception component 618 can include functionality to perform object tracking, detection, segmentation, and/or classification. In some examples, the perception component 618 can provide processed sensor data that indicates a presence of an entity that is proximate to the vehicle 602 and/or a classification of the entity as an entity type (e.g., car, pedestrian, cyclist, animal, building, tree, road surface, curb, sidewalk, unknown, etc.). In additional and/or alternative examples, the perception component 618 can provide processed sensor data that indicates one or more characteristics associated with a detected entity (e.g., a tracked object) and/or the environment in which the entity is positioned. In some examples, characteristics associated with an entity can include, but are not limited to, an x-position (global and/or local position), a y-position (global and/or local position), a z-position (global and/or local position), an orientation (e.g., a roll, pitch, yaw), an entity type (e.g., a classification), a velocity of the entity, an acceleration of the entity, an extent of the entity (size), etc. Characteristics associated with the environment can include, but are not limited to, a presence of another entity in the environment, a state of another entity in the environment, a time of day, a day of a week, a season, a weather condition, an indication of darkness/light, etc. In some instances, the perception component 618 may provide data to a web-based application that generates a data visualization associated with the vehicle 602 based at least in part on the data.

In general, the planning component 622 can determine a trajectory (sometimes referred to as a planned trajectory or path) for the vehicle 602 to follow to traverse through an environment. For example, the planning component 622 can determine various routes and trajectories and various levels of detail. For example, the planning component 624 can determine a route to travel from a first location (e.g., a current location) to a second location (e.g., a target location). For the purpose of this discussion, a route can be a sequence of waypoints for travelling between two locations. As examples, waypoints may include streets, intersections, global positioning system (GPS) coordinates, etc. Further, the planning component 624 can generate an instruction for guiding the autonomous vehicle along at least a portion of the route from the first location to the second location. In at least one example, the planning component 624 can determine how to guide the autonomous vehicle from a first waypoint in the sequence of waypoints to a second waypoint in the sequence of waypoints. In some examples, the instruction can be a trajectory, or a portion of a trajectory. In some examples, multiple trajectories can be substantially simultaneously generated (e.g., within technical tolerances) in accordance with a receding horizon technique, wherein one of the multiple trajectories is selected for the vehicle 602 to navigate.

In at least one example, the vehicle computing device 604 can include one or more system controllers 630, which can be configured to control steering, propulsion, braking, safety, emitters, communication, components, and other systems of the vehicle 602. These system controller(s) 630 can communicate with and/or control corresponding systems of the drive assembly(s) or system 612 and/or other components of the vehicle 602.

The memory 616 can further include the map(s) component 624 to maintain and/or update one or more maps (not shown) that can be used by the vehicle 602 to navigate within the environment. For the purpose of this discussion, a map can be any number of data structures modeled in two dimensions, three dimensions, or N-dimensions that are capable of providing information about an environment, such as, but not limited to, topologies (such as intersections), streets, mountain ranges, roads, terrain, and the environment in general. In some instances, a map can include, but is not limited to: texture information (e.g., color information (e.g., RGB color information, Lab color information, HSV/HSL color information), and the like), intensity information (e.g., lidar information, radar information, and the like); spatial information (e.g., image data projected onto a mesh, individual “surfels” (e.g., polygons associated with individual color and/or intensity)), reflectivity information (e.g., specularity information, retroreflectivity information, BRDF information, BSSRDF information, and the like). In one example, a map can include a three-dimensional mesh of the environment. In some instances, the map can be stored in a tiled format, such that individual tiles of the map represent a discrete portion of an environment and can be loaded into working memory as needed. In at least one example, the one or more maps can include at least one map (e.g., images and/or a mesh). In some examples, the vehicle 602 can be controlled based at least in part on the maps. That is, the maps can be used in connection with the localization component 620, the perception component 618, and/or the planning component 622 to determine a location of the vehicle 602, identify objects in an environment, and/or generate routes and/or trajectories to navigate within an environment. Additionally, the maps can be used in connection with the web-based application to generate content associated with the vehicle 602, such as a data visualization.

In some examples, the one or more maps can be stored on a remote computing device(s) (such as the computing device(s) 632) accessible via one or more network(s) 638. In some examples, multiple maps can be stored based on, for example, a characteristic (e.g., type of entity, time of day, day of week, season of the year, etc.). Storing multiple maps can have similar memory requirements but increase the speed at which data in a map can be accessed.

The memory 616 may also store log data 626 associated with the vehicle. For instance, the log data 626 may include one or more of diagnostic messages, notes, routes, etc. associated with the vehicle. By way of example, if information associated with a notification (e.g., diagnostic message) that is presented on a system interface of the user interface is copied and saved, the information may be stored in the log data 626.

In some instances, aspects of some or all of the memory-stored components discussed herein can include any models, algorithms, and/or machine learning algorithms. For example, in some instances, components in the memory 616 (and the memory 636, discussed in further detail below) such as the localization component 620, the perception component 618, and/or the planning component 622 can be implemented as a neural network.

As described herein, an exemplary neural network is a biologically inspired algorithm which passes input data through a series of connected layers to produce an output. Each layer in a neural network can also comprise another neural network or can comprise any number of layers (whether convolutional or not). As can be understood in the context of this disclosure, a neural network can utilize machine learning, which can refer to a broad class of such algorithms in which an output is generated based on learned parameters.

Although discussed in the context of neural networks, any type of machine learning can be used consistent with this disclosure. For example, machine learning algorithms can include, but are not limited to, regression algorithms (e.g., ordinary least squares regression (OLSR), linear regression, logistic regression, stepwise regression, multivariate adaptive regression splines (MARS), locally estimated scatterplot smoothing (LOESS)), instance-based algorithms (e.g., ridge regression, least absolute shrinkage and selection operator (LASSO), elastic net, least-angle regression (LARS)), decisions tree algorithms (e.g., classification and regression tree (CART), iterative dichotomiser 3 (ID3), Chi-squared automatic interaction detection (CHAID), decision stump, conditional decision trees), Bayesian algorithms (e.g., naïve Bayes, Gaussian naïve Bayes, multinomial naïve Bayes, average one-dependence estimators (AODE), Bayesian belief network (BNN), Bayesian networks), clustering algorithms (e.g., k-means, k-medians, expectation maximization (EM), hierarchical clustering), association rule learning algorithms (e.g., perceptron, back-propagation, hopfield network, Radial Basis Function Network (RBFN)), deep learning algorithms (e.g., Deep Boltzmann Machine (DBM), Deep Belief Networks (DBN), Convolutional Neural Network (CNN), Stacked Auto-Encoders), Dimensionality Reduction Algorithms (e.g., Principal Component Analysis (PCA), Principal Component Regression (PCR), Partial Least Squares Regression (PLSR), Sammon Mapping, Multidimensional Scaling (MDS), Projection Pursuit, Linear Discriminant Analysis (LDA), Mixture Discriminant Analysis (MDA), Quadratic Discriminant Analysis (QDA), Flexible Discriminant Analysis (FDA)), Ensemble Algorithms (e.g., Boosting, Bootstrapped Aggregation (Bagging), AdaBoost, Stacked Generalization (blending), Gradient Boosting Machines (GBM), Gradient Boosted Regression Trees (GBRT), Random Forest), SVM (support vector machine), supervised learning, unsupervised learning, semi-supervised learning, etc. Additional examples of architectures include neural networks such as ResNet50, ResNet101, VGG, DenseNet, PointNet, and the like.

In at least one example, the sensor system(s) 606 can include lidar sensors, radar sensors, ultrasonic transducers, sonar sensors, location sensors (e.g., GPS, compass, etc.), inertial sensors (e.g., inertial measurement units (IMUs), accelerometers, magnetometers, gyroscopes, etc.), image sensors (e.g., camera, RGB, IR, intensity, depth, etc.), audio sensors (e.g., microphones), wheel encoders, environment sensors (e.g., temperature sensors, humidity sensors, light sensors, pressure sensors, etc.), temperature sensors (e.g., for measuring temperatures of vehicle components), etc. The sensor system(s) 606 can include multiple instances of each of these or other types of sensors. For instance, the lidar sensors can include individual lidar sensors located at the corners, front, back, sides, and/or top of the vehicle 602. As another example, the image sensors can include multiple image sensors disposed at various locations about the exterior and/or interior of the vehicle 602. As an even further example, the audio sensors can include multiple audio sensors disposed at various locations about the exterior and/or interior of the vehicle 602. Additionally, the audio sensors can include an array of a plurality of audio sensors for determining directionality of audio data. The sensor system(s) 606 can provide input to the vehicle computing device 604. Additionally, or alternatively, the sensor system(s) 606 can send sensor data, via the one or more networks 638, to the one or more computing device(s) 632 at a particular frequency, after a lapse of a predetermined period of time, in near real-time, etc.

The vehicle 602 can also include one or more emitters 608 for emitting light and/or sound. The emitters 608 in this example include interior audio and visual emitters to communicate with occupants of the vehicle 602. By way of example, interior emitters can include speakers, lights, signs, display screens, touch screens, haptic emitters (e.g., vibration and/or force feedback), mechanical actuators (e.g., seatbelt tensioners, seat positioners, headrest positioners, etc.), and the like. The emitters 608 in this example also include exterior emitters. By way of example, the exterior emitters in this example include lights to signal a direction of travel or other indicator of vehicle action (e.g., indicator lights, signs, light arrays, etc.), and one or more audio emitters (e.g., speakers, speaker arrays, horns, etc.) to audibly communicate with pedestrians or other nearby vehicles, one or more of which comprising acoustic beam steering technology.

The vehicle 602 can also include one or more communication connection(s) 610 that enable communication between the vehicle 602 and one or more other local or remote computing device(s). For instance, the communication connection(s) 610 can facilitate communication with other local computing device(s) on the vehicle 602 and/or the drive system(s) 614. Also, the communication connection(s) 610 can allow the vehicle 602 to communicate with other nearby computing device(s) (e.g., other nearby vehicles, traffic signals, laptop computer etc.). The communications connection(s) 610 also enable the vehicle 602 to communicate with a remote teleoperations system or other remote services.

The communications connection(s) 610 can include physical and/or logical interfaces for connecting the vehicle computing device(s) 604 to another computing device (e.g., computing device(s) 632) and/or a network, such as network(s) 638. For example, the communications connection(s) 610 can enable Wi-Fi-based communication such as via frequencies defined by the IEEE 602.11 standards, short range wireless frequencies such as Bluetooth®, cellular communication (e.g., 2G, 3G, 4G, 4G LTE, 5G, etc.) or any suitable wired or wireless communications protocol that enables the respective computing device to interface with the other computing device(s).

In at least one example, a direct connection (not shown) of vehicle 602 can provide a physical interface to couple the one or more drive system(s) 612 with the body of the vehicle 602. For example, the direct connection can allow the transfer of energy, fluids, air, data, etc. between the drive system(s) 612 and the vehicle 602. In some instances, the direct connection can further releasably secure the drive system(s) 612 to the body of the vehicle 602.

In at least one example, the vehicle 602 can include one or more drive systems 612. In some examples, the vehicle 602 can have a single drive assembly 612. In at least one example, if the vehicle 602 has multiple drive systems 612, individual drive systems 614 can be positioned on opposite longitudinal ends of the vehicle 602 (e.g., the leading and trailing ends, the front and the rear, etc.).

The drive system(s) 612 can include many of the vehicle systems and/or components, including a high voltage battery, a motor to propel the vehicle, an inverter to convert direct current from the battery into alternating current for use by other vehicle systems, a steering system including a steering motor and steering rack (which can be electric), a braking system including hydraulic or electric actuators, a suspension system including hydraulic and/or pneumatic components, a stability control system for distributing brake forces to mitigate loss of traction and maintain control, an HVAC system, lighting (e.g., lighting such as head/tail lights to illuminate an exterior surrounding of the vehicle), and one or more other systems (e.g., cooling system, safety systems, onboard charging system, other electrical components such as a DC/DC converter, a high voltage junction, a high voltage cable, charging system, charge port, etc.). Additionally, the drive system(s) 614 can include one or more drive system controllers which can receive and preprocess data from the sensor system(s) and to control operation of the various vehicle systems. In some examples, the drive system controller(s) can include one or more processors and memory communicatively coupled with the one or more processors. The memory can store one or more systems to perform various functionalities of the drive system(s) 612. Furthermore, the drive assembly(s) 612 may also include one or more communication connection(s) that enable communication by the respective drive assembly with one or more other local or remote computing device(s).

The computing device(s) 632 can include one or more processors 634, a memory 636 that may be communicatively coupled to the one or more processors 634, and software 631 stored by the memory 636. In some examples, the computing device(s) 632 may be associated with a teleoperations system that remotely monitors a fleet of vehicles, such as teleoperator computer system 210 described in relation to FIGS. 1-4. In such an example, the software 631 may comprise the various software components 112-116 of the teleoperator computing system 210 described in relation to FIG. 4. Additionally, or alternatively, the computing devices(s) 632 may be leveraged by the teleoperations system to receive and/or process data on behalf of the teleoperations system.

The processor(s) 614 of the vehicle 602 and the processor(s) 634 of the computing device(s) 632 can be any suitable processor capable of executing instructions to process data and perform operations as described herein. By way of example and not limitation, the processor(s) 614 and 634 can comprise one or more Central Processing Units (CPUs), Graphics Processing Units (GPUs), or any other device or portion of a device that processes electronic data to transform that electronic data into other electronic data that can be stored in registers and/or memory. In some examples, integrated circuits (e.g., ASICs, etc.), gate arrays (e.g., FPGAs, etc.), and other hardware devices can also be considered processors in so far as they are configured to implement encoded instructions.

Memory 616 and 636 are examples of non-transitory computer-readable media. The memory 616 and 636 can store an operating system and one or more software applications, components, instructions, programs, and/or data to implement the methods described herein and the functions attributed to the various systems. In various implementations, the memory can be implemented using any suitable memory technology, such as static random-access memory (SRAM), synchronous dynamic RAM (SDRAM), nonvolatile/Flash-type memory, or any other type of memory capable of storing information. The architectures, systems, and individual elements described herein can include many other logical, programmatic, and physical components, of which those shown in the accompanying figures are merely examples that are related to the discussion herein.

As can be understood, the components of the vehicle 602 of FIG. 6 are described herein as divided for illustrative purposes. However, the operations performed by the various components can be combined or performed in any other component. It should be noted that while FIG. 6 is illustrated as a distributed system, in alternative examples, components of the vehicle 602 can be associated with the computing device(s) 632 and/or components of the computing device(s) 632 can be associated with the vehicle 602. That is, the vehicle 602 can perform one or more of the functions associated with the computing device(s) 632, and vice versa.

Whilst the intermittent stopping action discussed in relation to the above techniques has been described in relation to a selected or determined stop location, in other examples, the intermittent stopping action may be associated with a selected or determined stop time, the stop time defining the time at which the stopping action occurs or is initiated. For example, a stop time may be incorporated into an intermittent stopping action request based on one or more of: a potential event or an event in the environment that is determined by the teleoperator or teleoperator computer system to potentially affect the vehicle; and conditions relating to the vehicle, for example, a remaining battery level or performance of one or more systems of the vehicle. For instance, the stop time may be used as an alternative or in addition to the stop location. In the latter scenario, the intermittent stopping action message may configure the vehicle to stop at a stop location at a specific time, the stop time, where the vehicle computing system updates the trajectory of the vehicle and modifies its operation within the environment and along the route so that the vehicle reaches the stop location at the specified time.

Although the subject matter has been described in language specific to structural features and/or methodological acts, it is to be understood that the subject matter defined in the appended claims is not necessarily limited to the specific features or acts described. Rather, the specific features and acts are disclosed as example forms of implementing the claims.

The components described herein represent instructions that may be stored in any type of computer-readable medium and may be implemented in software and/or hardware. All of the methods and processes described above may be embodied in, and fully automated via, software code components and/or computer-executable instructions executed by one or more computers or processors, hardware, or some combination thereof. Some or all of the methods may alternatively be embodied in specialized computer hardware.

At least some of the processes discussed herein are illustrated as logical flow graphs, each operation of which represents a sequence of operations that can be implemented in hardware, software, or a combination thereof. In the context of software, the operations represent computer-executable instructions stored on one or more non-transitory computer-readable storage media that, when executed by one or more processors, cause a computer or autonomous vehicle to perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes.

Conditional language such as, among others, “may,” “could,” “may” or “might,” unless specifically stated otherwise, are understood within the context to present that certain examples include, while other examples do not include, certain features, elements and/or steps. Thus, such conditional language is not generally intended to imply that certain features, elements and/or steps are in any way required for one or more examples or that one or more examples necessarily include logic for deciding, with or without user input or prompting, whether certain features, elements and/or steps are included or are to be performed in any particular example.

Conjunctive language such as the phrase “at least one of X, Y or Z,” unless specifically stated otherwise, is to be understood to present that an item, term, etc. may be either X, Y, or Z, or any combination thereof, including multiples of each element. Unless explicitly described as singular, “a” means singular and plural.

Any routine descriptions, elements or blocks in the flow diagrams described herein and/or depicted in the attached figures should be understood as potentially representing modules, segments, or portions of code that include one or more computer-executable instructions for implementing specific logical functions or elements in the routine. Alternate implementations are included within the scope of the examples described herein in which elements or functions may be deleted or executed out of order from that shown or discussed, including substantially synchronously, in reverse order, with additional operations, or omitting operations, depending on the functionality involved as would be understood by those skilled in the art. Note that the term substantially may indicate a range. For example, substantially simultaneously may indicate that two activities occur within a time range of each other, substantially a same dimension may indicate that two elements have dimensions within a range of each other, and/or the like.

Many variations and modifications may be made to the above-described examples, the elements of which are to be understood as being among other acceptable examples. All such modifications and variations are intended to be included herein within the scope of this disclosure and protected by the following claims.

### EXAMPLE CLAUSES

A: A system comprising one or more processors; and one or more non-transitory computer readable media having instructions stored thereon wherein, when executed by the one or more processors, cause the one or more processors to perform operations comprising: receiving, at a remote computer system, data associated with an autonomous vehicle traversing an environment along a route in accordance with a planned trajectory and data associated with an event within the environment; causing a display to display a representation of the autonomous vehicle; receiving, at the remote computer system, a request to generate an intermittent stopping action message comprising: one or more of a position or orientation, and a period of time; and transmitting the intermittent stopping action message to the autonomous vehicle, wherein the autonomous vehicle is configured to determine an updated trajectory comprising the one or more of the position or orientation and move to the one or more of position or orientation for the period of time such that the vehicle moves to or is at the one or more of position or orientation prior to the event occurring.

B: a system as clause A describes, wherein the position or the orientation is within a stopping range of the autonomous vehicle defined by a minimum stopping distance determined based on a current speed of the autonomous vehicle.

C: a system as clause A and B describe, wherein the operations comprise: determining, based at least in part on the data associated with the vehicle and the data associated with the event and the planned trajectory, a likelihood that the autonomous vehicle will encounter the event; and causing the display to display an indication of the likelihood.

D: a system as clauses A to C describe, wherein the operations comprise: determining, at the remote computer system, that the vehicle is able to proceed safely along the route.

E: a system as clauses A to D describe, wherein the operations comprise: transmitting to the vehicle an instruction to proceed along the route, wherein the vehicle is configured to proceed along the route in accordance with the updated trajectory in response to receiving the instruction.

F: a system as clauses A to E describe, wherein the operations comprise: receiving, from the autonomous vehicle, a request to continue along the route; causing the display to display the request; receiving a response to the request indicative of allowing the autonomous vehicle to proceed; and transmitting the response to the autonomous vehicle, wherein the condition is receipt of the response.

G: A method comprising: receiving, from a vehicle, data associated with the vehicle traversing an environment and data associated with an event in the environment; receiving a command comprising one or more of a position or an orientation; and transmitting a message to the vehicle, based on the command, wherein the message configures the vehicle to move to the one or more of the position or the orientation until one or more of a period of time has elapsed or a condition is met, such that the vehicle moves to or is at the one or more of the position or the orientation prior to the event occurring within the environment.

H: a method as clause G describes, comprising: receiving, from the vehicle, a request to proceed; one or more of receiving or determining a response to the request; and transmitting the response to the vehicle, wherein the condition comprises receipt of the response by the vehicle.

I: a method as clauses G and H describe, wherein the vehicle comprises an autonomous vehicle executing a trajectory along a route, and the condition comprises a determination that the autonomous vehicle is able to proceed safely along the route.

J: a method as clauses G to I describe, wherein the position or the orientation is within a stopping range of the vehicle, the stopping range having a minimum corresponding to the minimum stopping distance of the vehicle based at least in part on a current speed of the autonomous vehicle.

K: a method as clauses G to J describe, wherein the message further configures the vehicle to perform one or more of: emit, as a passenger communication, one or more of an audio message or a video message internal to the vehicle, emit, as a pedestrian communication, one or more of a light or sound external to the vehicle, or initiate display of hazard lighting.

L: a method as clauses G to K describe, comprising determining, based at least in part on the data, a likelihood associated with the vehicle encountering the event; and causing a display to display an indication of the likelihood.

M: a method as clauses G to L describe, wherein receiving the command precedes a time associated with the event.

N: One or more non-transitory computer-readable media storing instructions executable by one or more processors, wherein the instructions, when executed, cause the one or more processors to perform operations comprising: receiving, from a vehicle, data associated with the vehicle traversing an environment and data associated with an event in the environment; receiving a command comprising one or more of: a position or an orientation; transmitting a message to the vehicle, based on the command, wherein the message configures the vehicle to move to the one or more of position or orientation until one or more of a predefined period of time has elapsed or a condition is met, such that the vehicle moves to or is at the one or more of the position or orientation prior to the event occurring in the environment.

O: one or more non-transitory computer-readable media as described by clause N, wherein the operations comprise: receiving, from the vehicle, a request to proceed; one or more of receiving or determining a response to the request; and transmitting the response to the vehicle, wherein the condition comprises receipt of the response by the vehicle.

P: one or more non-transitory computer-readable media as described by clauses N and O, wherein the vehicle comprises an autonomous vehicle executing a trajectory along a route and the position or the orientation is defined in a world frame of reference and wherein the operations comprise: calculating a distance between a current position of the autonomous vehicle and the position in the world frame of reference; and updating the trajectory to include an intermittent stop at the distance.

Q: one or more non-transitory computer-readable media as described by clauses N to P, wherein the position or the orientation is within a stopping range of the vehicle, the stopping range having a minimum corresponding to the minimum stopping distance of the vehicle based at least in part on a current speed of the autonomous vehicle.

R: one or more non-transitory computer-readable media as described by clauses N to Q, wherein the operations comprise: causing emittance of, as a passenger communication, one or more of an audio message or a video message internal to the vehicle; or causing emittance of, as a pedestrian communication, one or more of a light or sound external to the vehicle; or initiating display of hazard lighting.

S: one or more non-transitory computer-readable media as described by clauses N to R, wherein the operations comprise: determining, based at least in part on the data, a likelihood associated with the vehicle encountering the event; and causing a display to display an indication of the likelihood.

T: one or more non-transitory computer-readable media as described by clauses N to S, wherein receiving the command precedes a time associated with the event.

While the example clauses described above are described with respect to one particular implementation, it should be understood that, in the context of this document, the content of the example clauses can also be implemented via a method, device, system, computer-readable medium, and/or another implementation. Additionally, any of examples A-T may be implemented alone or in combination with any other one or more of the examples A-T.

What is claimed is:

1. A system comprising:
one or more processors; and
one or more non-transitory computer readable media having instructions stored thereon which, when executed by the one or more processors, cause the one or more processors to perform operations comprising:
receiving, at a remote computer system, data associated with an autonomous vehicle traversing an environment along a route in accordance with a planned trajectory and data associated with an event within the environment;
causing a display to display a representation of the autonomous vehicle;
receiving, at the remote computer system, a request to generate an intermittent stopping action message comprising:
one or more of a position or orientation, and
a period of time; and
transmitting the intermittent stopping action message to the autonomous vehicle, wherein the autonomous vehicle is configured to determine an updated trajectory comprising the one or more of the position or orientation and move to the one or more of position or orientation for the period of time such that the vehicle moves to or is at the one or more of position or orientation prior to the event occurring.

2. The system of claim 1, wherein the position or the orientation is within a stopping range of the autonomous vehicle defined by a minimum stopping distance determined based on a current speed of the autonomous vehicle.

3. The system of claim 1, wherein the operations comprise:
determining, based at least in part on the data associated with the autonomous vehicle and the data associated with the event and the planned trajectory, a likelihood that the autonomous vehicle will encounter the event; and
causing the display to display an indication of the likelihood.

4. The system of claim 1, wherein the operations comprise:
determining, at the remote computer system, that the vehicle is able to proceed safely along the route.

5. The system of claim 4, wherein the operations comprise:
transmitting to the vehicle an instruction to proceed along the route, wherein the vehicle is configured to proceed along the route in response to receiving the instruction.

6. The system of claim 4, wherein the operations comprise:
receiving, from the autonomous vehicle, a request to continue along the route;
causing the display to display the request;
receiving a response to the request indicative of allowing the autonomous vehicle to proceed; and
transmitting the response to the autonomous vehicle, wherein the condition is receipt of the response.

7. A method comprising:
receiving, from a vehicle, data associated with the vehicle traversing an environment and data associated with an event in the environment;
receiving a command comprising one or more of a position or an orientation; and
transmitting a message to the vehicle, based on the command, wherein the message configures the vehicle to move to the one or more of the position or the orientation until one or more of a period of time has elapsed or a condition is met, such that the vehicle moves to or is at the one or more of the position or the orientation prior to the event occurring within the environment.

8. The method of claim 7, comprising:
receiving, from the vehicle, a request to proceed;
one or more of receiving or determining a response to the request; and
transmitting the response to the vehicle, wherein the condition comprises receipt of the response by the vehicle.

9. The method of claim 7, wherein the vehicle comprises an autonomous vehicle executing a trajectory along a route, and the condition comprises a determination that the autonomous vehicle is able to proceed safely along the route.

10. The method of claim 9, wherein the position or the orientation is within a stopping range of the vehicle, the stopping range having a minimum corresponding to the minimum stopping distance of the vehicle based at least in part on a current speed of the autonomous vehicle.

11. The method of claim 7, wherein the message configures the vehicle to perform one or more of:
emit, as a passenger communication, one or more of an audio message or a video message internal to the vehicle,
emit, as a pedestrian communication, one or more of a light or sound external to the vehicle, or
initiate display of hazard lighting.

12. The method of claim 7 comprising:
receiving, based at least in part on the data associated with the vehicle and the data associated with the event, a likelihood associated with the vehicle encountering the event.

13. The method of claim 7 wherein receiving the command precedes a time associated with the event.

14. One or more non-transitory computer-readable media storing instructions executable by one or more processors, wherein the instructions, when executed, cause the one or more processors to perform operations comprising:
receiving, from a vehicle, data associated with the vehicle traversing an environment and data associated with an event in the environment;
receiving a command comprising one or more of: a position or an orientation;
transmitting a message to the vehicle, based on the command, wherein the message configures the vehicle to move to the one or more of position or orientation until one or more of a predefined period of time has elapsed or a condition is met, such that the vehicle moves to or is at the one or more of the position or orientation prior to the event occurring in the environment.

15. The one or more non-transitory computer-readable media of claim 14, wherein the operations comprise:
receiving, from the vehicle, a request to proceed;
one or more of receiving or determining a response to the request; and
transmitting the response to the vehicle, wherein the condition comprises receipt of the response by the vehicle.

16. The one or more non-transitory computer-readable media of claim 14, wherein the vehicle comprises an autonomous vehicle executing a trajectory along a route and the position or the orientation is defined in a world frame of reference and wherein the operations comprise:
calculating a distance between a current position of the autonomous vehicle and the position or orientation in the world frame of reference; and
updating the trajectory to include an intermittent stop at the distance.

17. The one or more non-transitory computer-readable media of claim 14, wherein the position or the orientation is within a stopping range of the vehicle, the stopping range having a minimum corresponding to the minimum stopping distance of the vehicle based at least in part on a current speed of the autonomous vehicle.

18. The one or more non-transitory computer-readable media of claim 14, wherein the operations comprise:
causing emittance of, as a passenger communication, one or more of an audio message or a video message internal to the vehicle; or
causing emittance of, as a pedestrian communication, one or more of a light or sound external to the vehicle; or
initiating display of hazard lighting.

19. The one or more non-transitory computer-readable media of claim 14, wherein the operations comprise:
determining, based at least in part on the data associated with the vehicle and the data associated with the event, a likelihood associated with the vehicle encountering the event.

20. The one or more non-transitory computer-readable media of claim 14, wherein receiving the command precedes a time associated with the event.
